(19) United States
(12) Patent Application Publication
(10) Pub. No.: US 2022/0393289 A1
(43) Pub. Date: Dec. 8, 2022

(54) SYSTEM FOR MANEUVERING AND COUPLING BATTERY PACK

(71) Applicants: Santiago MORAN, Curitiba (BR); Pablo KUBO, Curitiba (BR); Fernando ZARPELON, Curitiba (BR); VOLVO TRUCK CORPORATION, Goteborg (SE)

(72) Inventors: Santiago MORAN, Curitiba (BR); Pablo KUBO, Curitiba (BR); Femando ZARPELON, Curitiba (BR)

(21) Appl. No.: 17/756,008

(22) PCT Filed: Nov. 13, 2019
(86) PCT No.: PCT/IB2019/059754

§ 371 Date: May 13, 2022

(51) Int. Cl. H01M 50/249; H01M 50/262; B60L 53/80; B62D 53/08

(52) U.S. Cl. CPC H01M 50/249; H01M 50/262; B60L 53/80; B62D 53/08; H01M 2220/20; B60L 2200/28; B60L 2200/36

(57) ABSTRACT

A battery pack maneuvering system for a vehicle with a fifth wheel that includes a battery pack and an actuator. The battery pack is provided with a fifth wheel coupling member that removably couples the battery pack to a fifth wheel of a vehicle. The actuator is mounted onto the vehicle, removably couples to the battery pack, and lifts the battery pack to remove the battery pack from the fifth wheel.

### BACKGROUND

### 1. Technical Field

The present disclosure relates to electric vehicle, and more specifically to a system for maneuvering and coupling a battery pack for an electric vehicle.

### 2. Introduction

Conventionally a medium and heavy electric vehicle (e.g., truck tractor) has its battery pack disposed inside a chassis frame of the electric vehicle (e.g., a rigid truck chassis or trailer chassis). However, due to lack of available space on the electric vehicle (e.g., truck tractor) it may be difficult to located sufficient electrical power inside the chassis frame.

Therefore, there is a need for an improved battery pack system.

### SUMMARY

According to one example embodiment of the present invention, a battery pack maneuvering system includes a battery pack provided with a fifth wheel coupling member that removably couples the battery pack to a fifth wheel of a vehicle, and an actuator mounted onto the vehicle that is removably coupled to the battery pack and that lifts the battery pack to move the battery pack from the fifth wheel.

According to another example embodiment of the present invention, a system for maneuvering a battery pack and coupling the battery pack to a trailer includes a battery pack provided with a fifth wheel coupling member that removably couples the battery pack to a fifth wheel of a vehicle and a second coupling member adapted to removably couple to a trailer, an actuator mounted onto the vehicle to move the battery pack from the fifth wheel, whereby the battery pack is moved from a connected position coupled to the fifth wheel via the fifth wheel coupling member to a transfer position for transfer to the trailer, a trailer configured to be coupled to the fifth wheel, and a coupling structure adapted to fixedly attach to the trailer and to couple the battery pack to the trailer, the coupling structure comprises a connector having corresponding surfaces to engage with the second coupling member of the battery pack such that the battery pack is coupled to the trailer from the transfer position.

### ASPECTS

According to one aspect of the present invention, a battery pack maneuvering system, comprises:
a battery pack provided with a fifth wheel coupling member that removably couples the battery pack to a fifth wheel of a vehicle; and
an actuator mounted onto the vehicle that is removably coupled to the battery pack and that removes the battery pack from the fifth wheel.

Preferably, the actuator is adapted to transfer the battery pack to a trailer that may be coupled to the fifth wheel after the battery pack is removed from the fifth wheel.

Preferably, the actuator is adapted to lift and remove the battery pack from the fifth wheel to a location forward of the fifth wheel so that the trailer may couple to the fifth wheel.

Preferably, after the trailer is coupled to the fifth wheel the actuator moves the battery pack to the trailer whereat a trailer coupling member on the battery pack couples the battery pack to the trailer.

Preferably, after the trailer is coupled to the fifth wheel the actuator moves the battery pack to the trailer whereat a trailer coupling member on the battery pack couples the battery pack to the trailer. The actuator uncouples from the battery pack after the battery pack couples to the trailer.

Preferably, after the trailer is coupled to the fifth wheel the actuator moves the battery pack to the trailer whereat a trailer coupling member on the battery pack couples the battery pack to the trailer. After the trailer is coupled to the fifth wheel, the actuator removes the battery pack from the trailer and the trailer is subsequently uncoupled from the fifth wheel.

Preferably, the actuator is telescopic.

Preferably, the actuator is a crane.

Preferably, the actuator is configured to be fixed behind the body of the vehicle and forward of the fifth wheel. The body may include a cab.

Preferably, the actuator comprises a truss system configured to be movable along one or more rails on a frame of the vehicle.

Preferably, the actuator comprises a robot configured to be movable along one or more rails on a frame of the vehicle.

According to another aspect of the present invention, a system for maneuvering a battery pack and coupling the battery pack to a trailer, comprises:
a battery pack provided with a fifth wheel coupling member that removably couples the battery pack to a fifth wheel of a vehicle and a second coupling member adapted to removably couple to a trailer;
an actuator mounted onto the vehicle to move the battery pack from the fifth wheel, whereby the battery pack is moved from a connected position coupled to the fifth wheel via the fifth wheel coupling member to a transfer position for transfer to the trailer;
a trailer configured to be coupled to the fifth wheel; and
a coupling structure adapted to fixedly attach to the trailer and to couple the battery pack to the trailer, the coupling structure comprises a connector having corresponding surfaces to engage with the second coupling member of the battery pack such that the battery pack is coupled to the trailer from the transfer position.

Preferably, the second coupling member of the battery pack comprises at least one bumper at a lower portion of the battery pack facing the trailer.

Preferably, the actuator comprises a crane.

Preferably, the actuator is configured to be fixed behind the body of the vehicle and forward of the fifth wheel.

Preferably, the actuator comprises a truss system configured to be movable along one or more rails on a frame of the vehicle.

Preferably, the actuator comprises a robot configured to be movable along one or more rails on a frame of the vehicle.

### BRIEF DESCRIPTION OF THE DRAWINGS

FIG. 1A illustrates a side view of an exemplary system in which a battery pack is disposed at an A position, according to an example embodiment of the present disclosure;

FIG. 1B illustrates a perspective view of the exemplary system in FIG. 1A, according to an example embodiment of the present disclosure;

FIG. 2A illustrates a side view of the exemplary system in FIG. 1A in which the battery pack is disposed at a B position, according to an example embodiment of the present disclosure;

FIG. 2B illustrates a perspective view of the exemplary system in FIG. 2A, according to an example embodiment of the present disclosure;

FIG. 3A illustrates a side view of the exemplary system in FIG. 1A in which the battery pack is disposed at the B position and coupling an electric tractor to a trailer starts, according to an example embodiment of the present disclosure;

FIG. 3B illustrates a perspective view of the exemplary system in FIG. 3A, according to an example embodiment of the present disclosure;

FIG. 4A illustrates a side view of the exemplary system in FIG. 1A in which the battery pack is disposed at the B position and coupling the tractor to the trailer is continuing until it completes, according to an example embodiment of the present disclosure;

FIG. 4B illustrates a perspective view of the exemplary system in FIG. 4A, according to an example embodiment of the present disclosure;

FIG. 5A illustrates a side view of the exemplary system in FIG. 1A in which the battery pack is disposed at the B position and coupling the battery pack to the trailer starts, according to an example embodiment of the present disclosure;

FIG. 5B illustrates a perspective view of the exemplary system in FIG. 5A, according to an example embodiment of the present disclosure.

FIG. 6A illustrates a side view of the exemplary system in FIG. 1A in which the battery pack is raised from the B position to a C position, according to an example embodiment of the present disclosure;

FIG. 6B illustrates a perspective view of the exemplary system in FIG. 6A, according to an example embodiment of the present disclosure;

FIG. 7A illustrates a side view of the exemplary system in FIG. 1A in which the battery pack is raised to the C position and moving the battery pack from the C position toward the trailer may start in order to couple the battery pack to the trailer, according to an example embodiment of the present disclosure;

FIG. 7B illustrates a perspective view of the exemplary system in FIG. 7A, according to an example embodiment of the present disclosure;

FIG. 8A illustrates a side view of the exemplary system in FIG. 1A in which the battery pack is moved from the C position to a D position in order to couple the battery pack to the trailer, according to an example embodiment of the present disclosure;

FIG. 8B illustrates a perspective view of the exemplary system in FIG. 8A, according to an example embodiment of the present disclosure;

FIG. 9A illustrates a side view of the exemplary system in FIG. 1A in which the battery pack has been moved from the C position to the D position at which the battery pack is coupled to the trailer, according to an example embodiment of the present disclosure;

FIG. 9B illustrates a perspective view of the exemplary system in FIG. 9A, according to an example embodiment of the present disclosure;

FIG. 10A illustrates a side view of the exemplary system in FIG. 1A in which the actuator may be removed from the battery pack to decouple the actuator from the battery pack, according to an example embodiment of the present disclosure;

FIG. 10B illustrates a perspective view of the exemplary system in FIG. 10A, according to an example embodiment of the present disclosure;

FIG. 11A illustrates a side view of the exemplary system in FIG. 1A in which the actuator has been retracted from the position 1 to the position 2, according to an example embodiment of the present disclosure;

FIG. 11B illustrates a perspective view of the exemplary system in FIG. 11A, according to an example embodiment of the present disclosure;

FIG. 12A illustrates a side view of the exemplary system in FIG. 1A in which the actuator is further retracted from the position 2 to a position 3, according to an example embodiment of the present disclosure;

FIG. 12B illustrates a perspective view of the exemplary system 100 in FIG. 12A, according to an example embodiment of the present disclosure;

FIG. 13A illustrates a side view of the exemplary system in FIG. 1A in which the actuator has been retracted from the position 2 to the position 3, according to an example embodiment of the present disclosure;

FIG. 13B illustrates a perspective view of the exemplary system 100 in FIG. 13A, according to an example embodiment of the present disclosure;

FIG. 14A illustrates a side view of the exemplary system in FIG. 1A in which the actuator is further moved from the position 3 to a position 4, according to an example embodiment of the present disclosure;

FIG. 14B illustrates a perspective view of the exemplary system in FIG. 14A, according to an example embodiment of the present disclosure;

FIG. 15A illustrates a side view of the exemplary system in FIG. 1A in which the actuator has been moved to a final position, according to an example embodiment of the present disclosure;

FIG. 15B illustrates a perspective view of the exemplary system in FIG. 15A, according to an example embodiment of the present disclosure;

FIG. 16A illustrates a side view of the exemplary system in FIG. 1A in which the actuator is at the final position 5 and the electric tractor coupled to the trailer starts traveling, according to an example embodiment of the present disclosure;

FIG. 16B illustrates a perspective view of the exemplary system in FIG. 16A, according to an example embodiment of the present disclosure;

FIG. 17A illustrates a top view of a battery pack maneuvering system according to an example embodiment of the present disclosure;

FIG. 17B illustrates a side view of the battery pack maneuvering system in FIG. 17A according to an example embodiment of the present disclosure;

FIG. 17C illustrates another side view of the battery pack maneuvering system in FIG. 17A according to an example embodiment of the present disclosure;

FIG. 18A illustrates a top view of another battery pack maneuvering system according to an example embodiment of the present disclosure;

FIG. 18B illustrates a side view of the battery pack maneuvering system in FIG. 18A according to an example embodiment of the present disclosure;

FIG. 18C illustrates another side view of the battery pack maneuvering system in FIG. 18A according to an example embodiment of the present disclosure;

FIG. 19A illustrates a top view of yet another battery pack maneuvering system according to an example embodiment of the present disclosure;

FIG. 19B illustrates a side view of the battery pack maneuvering system in FIG. 19A according to an example embodiment of the present disclosure;

FIG. 19C illustrates another side view of the battery pack maneuvering system in FIG. 19A according to an example embodiment of the present disclosure;

FIG. 20A illustrates a perspective view of an example battery pack according to an example embodiment of the present disclosure;

FIG. 20B illustrates a back side view facing a trailer of the example battery pack in FIG. 20A according to an example embodiment of the present disclosure;

FIG. 20C illustrates an example coupling structure adapted to coupling the example battery pack in FIG. 20A to the trailer, according to an example embodiment of the present disclosure;

FIG. 20D illustrates a side view of the trailer and the example battery pack in FIG. 20A coupled to the trailer, according to an example embodiment of the present disclosure;

FIG. 21A illustrates a perspective view of an example battery pack according to an example embodiment of the present disclosure;

FIG. 21B illustrates a back side view facing a trailer of the example battery pack in FIG. 21A according to an example embodiment of the present disclosure;

FIG. 21C illustrates an example coupling structure adapted to coupling the example battery pack in FIG. 21A to the trailer, according to an example embodiment of the present disclosure;

FIG. 21D illustrates a side view of the trailer and the example battery pack in FIG. 21A coupled to the trailer, according to an example embodiment of the present disclosure;

FIG. 22A illustrates an example battery pack secured to a fifth wheel of a vehicle, according to an example embodiment of the present disclosure;

FIG. 22B illustrates an example actuator manipulating the battery pack of the vehicle of FIG. 22A, according to an example embodiment of the present disclosure;

FIG. 23A illustrates an example actuator disposed behind a cap of a vehicle for manipulating a battery pack, according to an example embodiment of the present disclosure;

FIG. 23B illustrates an example battery pack manipulated by the actuator of FIG. 23A, according to an example embodiment of the present disclosure;

FIG. 24A illustrates an example actuator for manipulating a battery pack, according to an example embodiment of the present disclosure;

FIG. 24B illustrates an example battery pack manipulated by the actuator of FIG. 24A, according to an example embodiment of the present disclosure; and

FIG. 25 illustrates an example actuator for manipulating a battery pack, according to an example embodiment of the present disclosure.

### DETAILED DESCRIPTION

Some embodiments of this disclosure are capable of maneuvering a battery pack to transfer the battery pack between an electric vehicle and a trailer that is adapted to couple to the electric vehicle, and are capable of coupling the battery pack to the trailer when the trailer is engaged with the electric vehicle. The battery pack can be moved from the trailer when desired, and installed on different trailers in an easy and quick manner. The disclosed systems may allow the battery pack coupled to the trailer to be easily and quickly replaced with a charged battery pack when the battery pack runs out of energy, such that the traveling range of the trailer and the electric vehicle can be extended. In some embodiments, the systems may also allow the battery pack to power the electric vehicle itself when the electric vehicle is not coupled to the trailer. For example, it may be desirable to drive just the electric vehicle before coupling it to a trailer. Embodiments of this disclosure can also be applied to electric vehicles and hybrid vehicles.

In some embodiments, a battery pack maneuvering system disclosed herein can include a battery pack provided with a fifth wheel coupling member that removably couples the battery pack to a fifth wheel of a vehicle; and an actuator mounted onto the vehicle that lifts the battery pack to remove the battery pack from the fifth wheel. The actuator subsequently transfers the battery pack to another location, in some examples this may be a trailer. The trailer may or may not be coupled to the fifth wheel at the time of the transfer. In an example, the actuator moves the battery pack from the fifth wheel so that the battery pack is located forward of the fifth wheel as the trailer couples to the fifth wheel and then the actuator moves the battery pack to the trailer. A trailer coupling member for the battery pack couples the battery pack to the trailer. In some embodiments, after the trailer is coupled to the fifth wheel, the actuator may remove the battery pack from the trailer and the trailer may be subsequently uncoupled from the fifth wheel with the actuator returning the battery pack to the fifth wheel.

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided.

Further, the below descriptions may concentrate on an electric tractor having a fifth wheel that is adapted to couple to a trailer, however, the disclosure may be equally applied to other suitable electric vehicles and other coupling mechanisms.

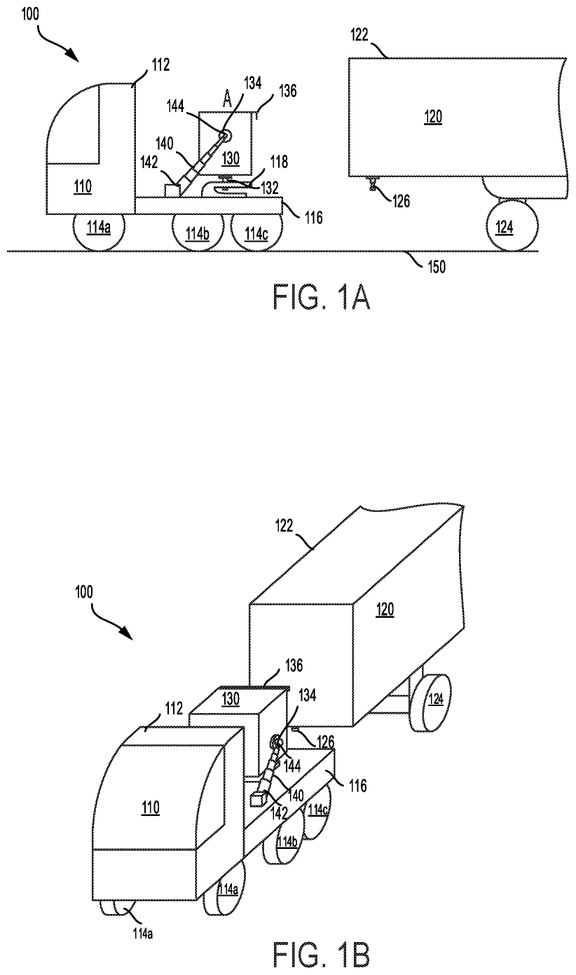

FIG. 1A illustrates a side view of an exemplary system 100 in which a battery pack is disposed at an A position, according to an example embodiment of the present disclosure. The system 100 may comprise an electric or hybrid tractor 110, a trailer 120, a battery pack 130, and one or more actuator 140. The system 100 may be positioned on a surface 150 (e.g., ground).

The electric tractor 110 may comprise a body 112, which may be a body of an autonomous vehicle or include a cab inside which a driver may sit, an example or more wheels 114 (e.g., 114a, 114b, 114c), and a vehicle frame 116 having a fifth wheel 118. The fifth wheel 118 may be adapted to removably couple to the battery pack 130 and the trailer 120.

The trailer 120 may comprise a body 122, one or more wheels 124, and a pin 126 connected to a bottom surface of the body 122. The pin 126 is adapted to removably couple to the fifth wheel 118. The pin 126 may be a king pin of various sizes and shapes. The pin 126 may also be any suitable coupling device of various sizes and shapes that can be adapted to removably couple to the fifth wheel 118.

The battery pack 130 may comprise a first coupling member 132 connected to a bottom surface of the battery pack 130, and a second coupling member 134 connected to a side surface of the battery pack 130. The first coupling member 132 may be a pin adapted to removably couple to the fifth wheel 118. The first coupling member 132 may also be any suitable coupling device of various sizes and shapes that can be adapted to removably couple to the fifth wheel 118. The second coupling member 134 is adapted to removably couple to the actuator 140. The battery pack 130 may further comprise a third coupling member 136 adapted to removably couple to the trailer 120.

The actuator 140 may be a telescopic actuator, such as a hydraulic or a pneumatic actuator, or any other suitable actuator. The actuator 140 may have a first end 142 and a second end 144 opposite the first end 142. The first end 142 may be adapted to rotatably couple to the vehicle frame 116 and to move between a first position and a second position. The second end 144 may be extendable and retractable with respect to the first end 142 to move between an extended position and a retracted position. The second end 144 is adapted to removably couple to the battery pack 130 via the second coupling member 134 of the battery pack 130.

In FIG. 1A, the battery pack 130 is disposed at a position A, which is coupled to both the fifth wheel 118 via the first coupling member 132 of the battery pack 130, and the actuator 140 via the second coupling member 134. The electric tractor 110 has not been coupled to the trailer 120 yet.

FIG. 1B illustrates a perspective view of the exemplary system 100 in FIG. 1A, according to an example embodiment of the present disclosure. As seen in FIG. 1B, the second coupling member 134 may comprise at least on pin-shaped protrusion. Each pin-shaped protrusion has a first end adapted to connect to a corresponding side surface of the battery pack 130, and a second end extending away from the corresponding side surface of the battery pack 130 respectively. The third coupling member 136 of the battery pack 130 may comprise a coupling member having a hook-shaped cross-section. The third coupling member 136 may be connected to an edge of the battery pack 130 facing the trailer 120 and run through the edge of the battery pack 130.

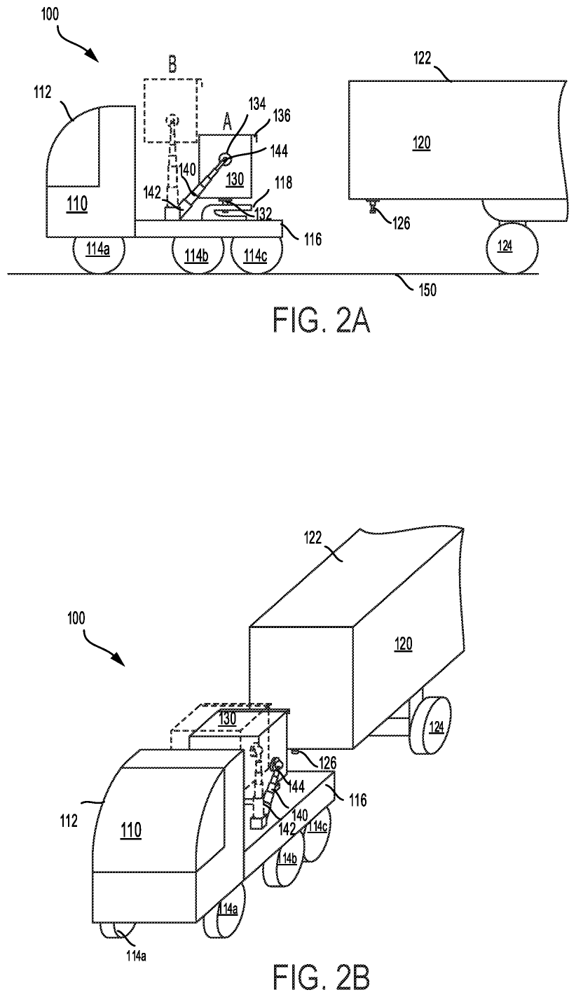

FIG. 2A illustrates a side view of the exemplary system 100 in which the battery pack 130 is disposed at a B position, according to an example embodiment of the present disclosure. FIG. 2B illustrates a perspective view of the exemplary system 100 in FIG. 2A, according to an example embodiment of the present disclosure. In FIGS. 2A and 2B, the battery pack 130 is disposed at the position B as shown by the dashed lines, which is moved from the position A by the actuator 140. To move the battery pack 130 from the position A to the position B, the first end 142 of the actuator 140 may rotate from a first positon corresponding to the position A to a second position corresponding to the position B with respect to the vehicle frame 116, such that the first coupling member 132 of the battery pack 130 may be lifted out of the fifth wheel 118 to decouple the battery pack 130 from the fifth wheel 118. Meanwhile, the second end 144 of the actuator 140 may be extended with respect to the first end 142 to raise the battery pack 130 from a first height position corresponding to the position A to a second height position corresponding to the position B. At the position B, the battery pack 130 is released from the fifth wheel 118. The electric tractor 110 has not been coupled to the trailer 120 yet.

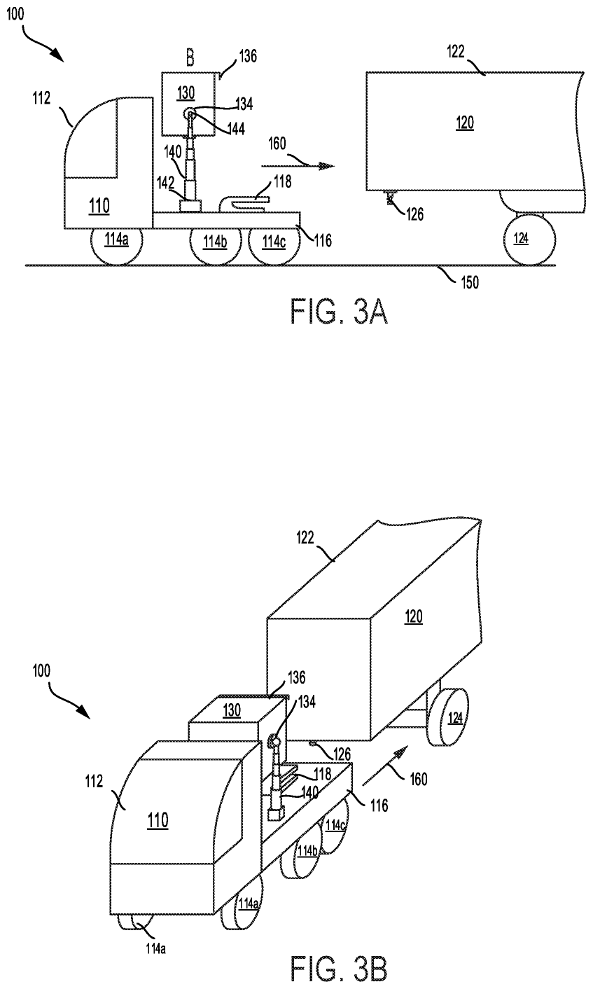

FIG. 3A illustrates a side view of the exemplary system 100 in which the battery pack 130 is disposed at the B position and coupling the electric tractor 110 to the trailer 120 starts, according to an example embodiment of the present disclosure. FIG. 3B illustrates a perspective view of the exemplary system 100 in FIG. 3A, according to an example embodiment of the present disclosure. In FIGS. 3A and 3B, the battery pack 130 is disposed at the position B, and coupling the electric tractor 110 to the trailer 120 may start. The electric tractor 110 may be driven backward toward to the trailer 120 to start the coupling process, as shown by the arrow 160.

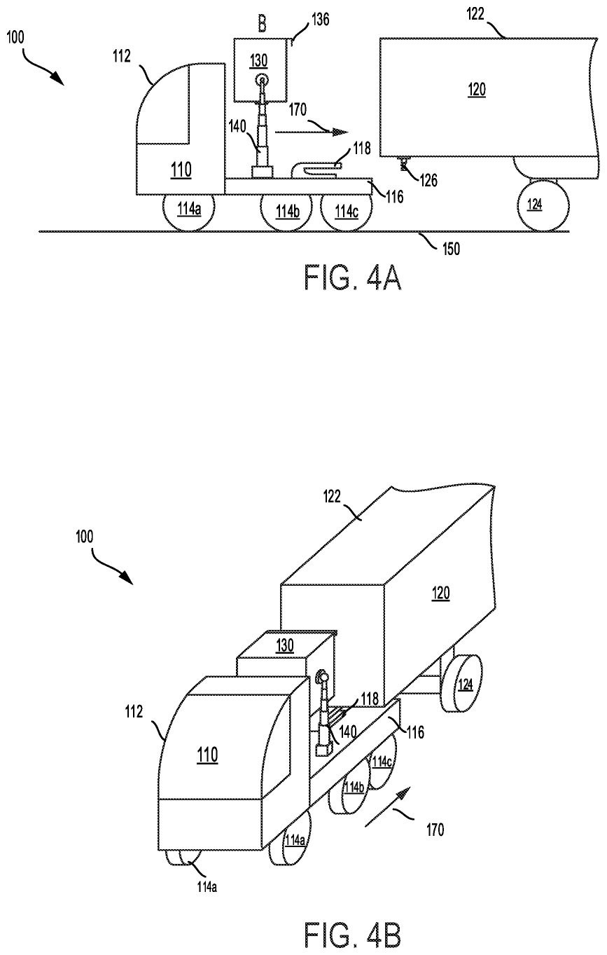

FIG. 4A illustrates a side view of the exemplary system 100 in which the battery pack 130 is disposed at the B position and coupling the electric tractor 110 to the trailer 120 is continuing until it completes, according to an example embodiment of the present disclosure. FIG. 4B illustrates a perspective view of the exemplary system 100 in FIG. 4A, according to an example embodiment of the present disclosure. In FIGS. 4A and 4B, the battery pack 130 is disposed at the position B, and coupling the electric tractor 110 to the trailer 120 may continue until it completes. The electric tractor 110 may be driven backward continually toward to the trailer 120 until the coupling process is completed, as shown by the arrow 170. When the coupling process completes, the pin 126 of the trailer 120 is coupled to the fifth wheel 118, as known in the prior art.

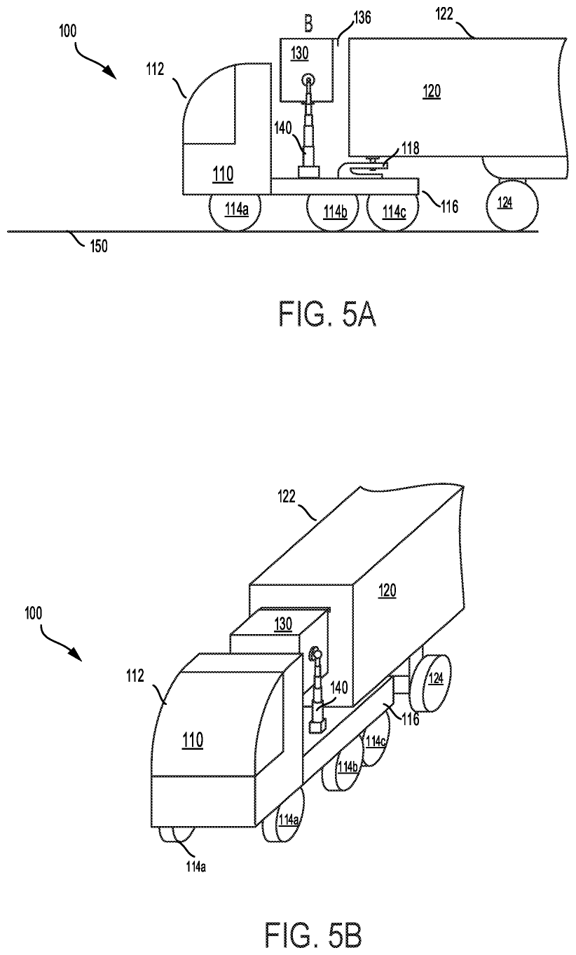

FIG. 5A illustrates a side view of the exemplary system 100 in which the battery pack 130 is disposed at the B position and coupling the battery pack 130 to the trailer 120 starts, according to an example embodiment of the present disclosure. FIG. 5B illustrates a perspective view of the exemplary system 100 in FIG. 5A, according to an example embodiment of the present disclosure. In FIGS. 5A and 5B, the battery pack 130 is disposed at the position B, and coupling the battery pack 130 to the trailer 120 may start. The electric tractor 110 has been coupled to the trailer 120 via the fifth wheel 118 of the electric tractor 110 and the pin 126 of the trailer 120. A top surface of the battery pack 130 may be at a height equal to or less than a height of a top surface of the trailer 120. In order to couple the battery pack 130 to the trailer 120, the height of the top surface of the battery pack 130 may need to be raised to a height greater than the height of the top surface of the trailer 120.

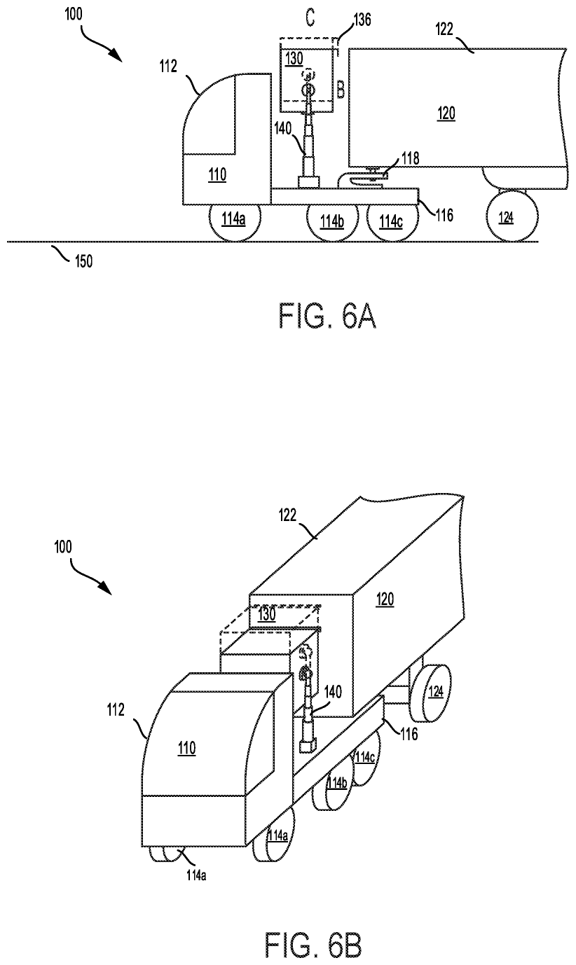

FIG. 6A illustrates a side view of the exemplary system 100 in which the battery pack 130 is raised from the B position to a C position by the actuator 140, according to one embodiment of the present disclosure. FIG. 6B illustrates a perspective view of the exemplary system 100 in FIG. 6A, according to one embodiment of the present disclosure. As discussed above, the height of the top surface of the battery pack 130 may need to be raised to a height greater than the height of the top surface of the trailer 120 in order to couple the battery pack 130 to the trailer 120. In this example, the battery pack 130 may be raised to the C position from the B position by the actuator 140 that extends the second end 144 of the actuator 140 away from the first end 142 of the actuator 140, which is shown in dashed lines. As can be seen, the height of the tops surface of the battery pack 130 at the C position is greater than the height of the top surface of the trailer 120. At the C position, the battery pack 130 is moved from a connected position coupled to the fifth wheel 118 via the second coupling member 134 of the battery pack 130 to a transfer position for transfer to the trailer 120.

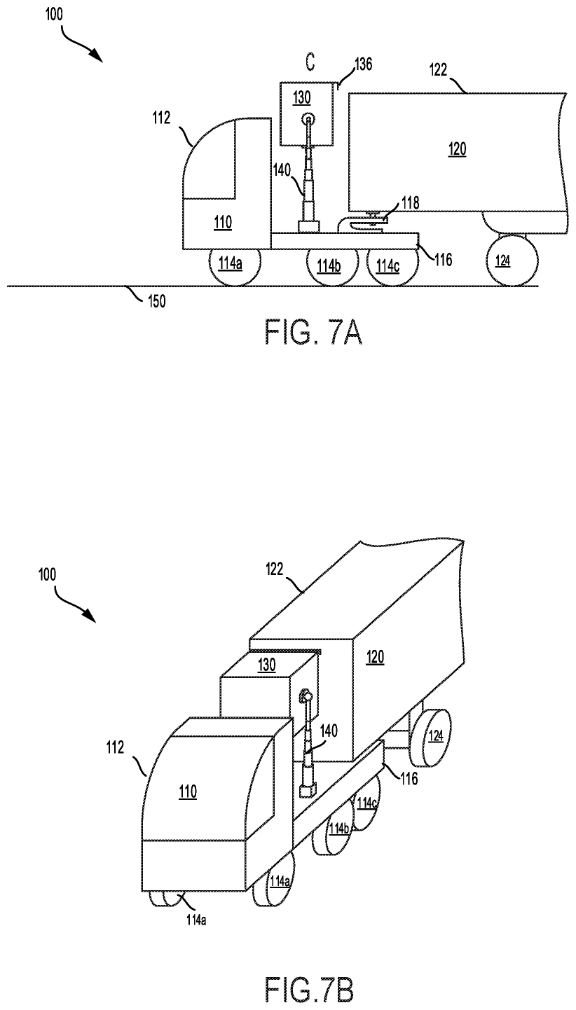

FIG. 7A illustrates a side view of the exemplary system 100 in which the battery pack 130 is raised to the C position by the actuator 140 and moving the battery pack 130 from the C position toward the trailer 120 may start in order to couple the battery pack 130 to the trailer 120, according to one embodiment of the present disclosure. FIG. 7B illustrates a perspective view of the exemplary system 100 in FIG. 7A, according to one embodiment of the present disclosure. Once the battery pack 130 is raised to the C position from the B position by the actuator 140, which is a proper height for transferring the battery pack 130 to the trailer 120, the battery pack 130 may be moved by the actuator 140 toward the trailer 120 in order to couple the battery pack 130 to the trailer 120.

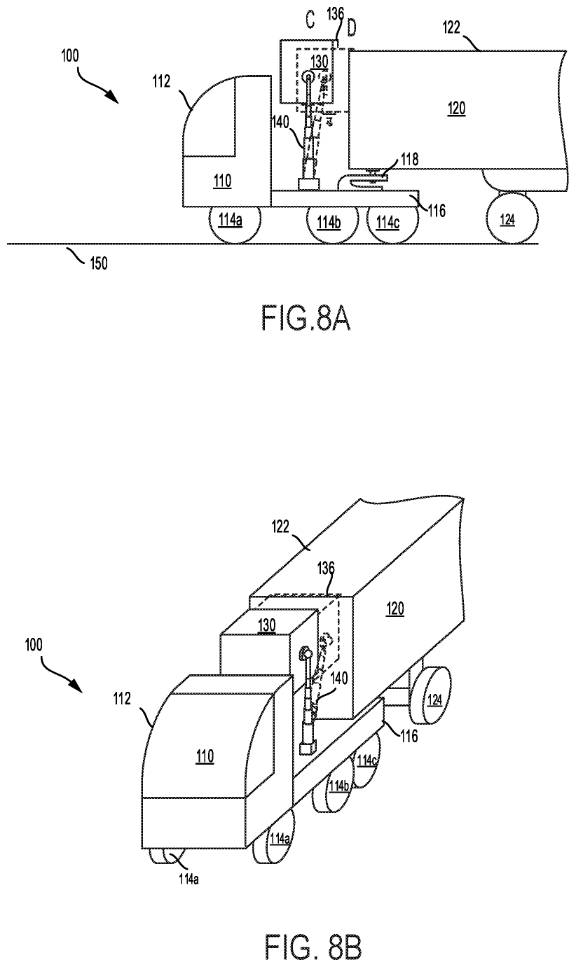

FIG. 8A illustrates a side view of the exemplary system 100 in which the battery pack 130 is moved by the actuator 140 from the C position to a D position in order to couple the battery pack 130 to the trailer 120, according to one embodiment of the present disclosure. FIG. 8B illustrates a perspective view of the exemplary system 100 in FIG. 8A, according to one embodiment of the present disclosure. Once the battery pack 130 is raised to the C position from the B position by the actuator 140, which is a proper height for transferring the battery pack 130 to the trailer 120, the battery pack 130 may be moved by the actuator 140 toward the trailer 120 from the C position to the D position in order to couple the battery pack 130 to the trailer 120, which is shown in dashed lines. To move the battery pack 130 from the C position to the D position, the first end 142 of the actuator 140 may rotate with respect to the vehicle frame 116 from a position corresponding to the C position to a position corresponding to the D position. The D positon may be position at which the battery pack 130 is coupled to the trailer 120 via the third coupling member 136 of the battery pack 130.

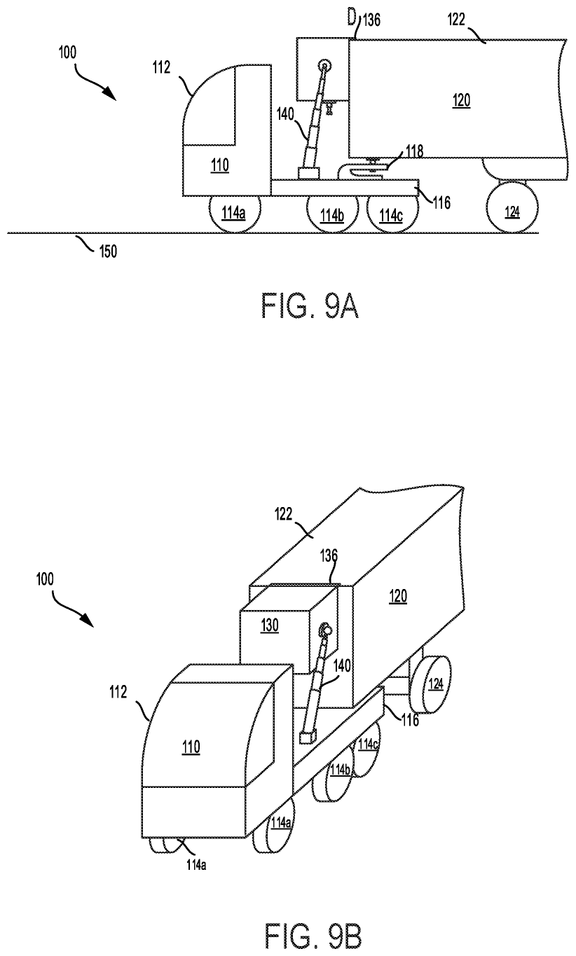

FIG. 9A illustrates a side view of the exemplary system 100 in which the battery pack 130 is moved by the actuator 140 from the C position to a D position at which the battery pack 130 is coupled to the trailer 120, according to an example embodiment of the present disclosure. FIG. 9B illustrates a perspective view of the exemplary system 100 in FIG. 9A, according to an example embodiment of the present disclosure. Once the battery pack 130 is moved to the D position at which the battery pack 130 is coupled to the trailer 120, the actuator 140 may be removed from the battery pack 130 to decouple the actuator 140 from the battery pack 130. In order to decouple the actuator 140 from the battery pack 130, the second end 144 of the actuator 140 may be retracted with respect to the first end 142 of the actuator 140 from the position at which the second end 144 of the actuator 140 is coupled to the second coupling member 134 of the battery pack 130 to a position at which the second end 144 of the actuator 140 is decoupled from the second coupling member 134 of the battery pack 130. This may be achieved by retracting one step of the actuator 140 (e.g., one step of a telescopic hydraulic actuator).

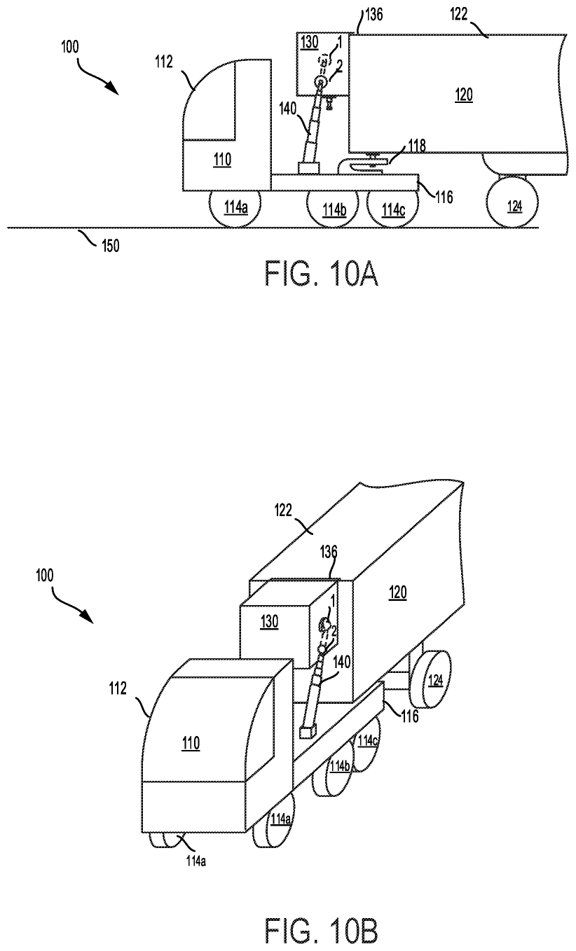

FIG. 10A illustrates a side view of the exemplary system 100 in which the actuator 140 may be removed from the battery pack 130 to decouple the actuator 140 from the battery pack 130, according to an example embodiment of the present disclosure. FIG. 10B illustrates a perspective view of the exemplary system 100 in FIG. 10A, according to an example embodiment of the present disclosure. In order to decouple the actuator 140 from the battery pack 130, the second end 144 of the actuator 140 may be retracted with respect to the first end 142 of the actuator 140 from a position 1 at which the second end 144 of the actuator 140 is coupled to the second coupling member 134 of the battery pack 130 to a position 2 at which the second end 144 of the actuator 140 is decoupled from the second coupling member 134 of the battery pack 130. This can be shown by dashed lines illustrating the movement of the second end 144 of the actuator 140 from the position 1 to the position 2 in FIGS. 10A and 10B.

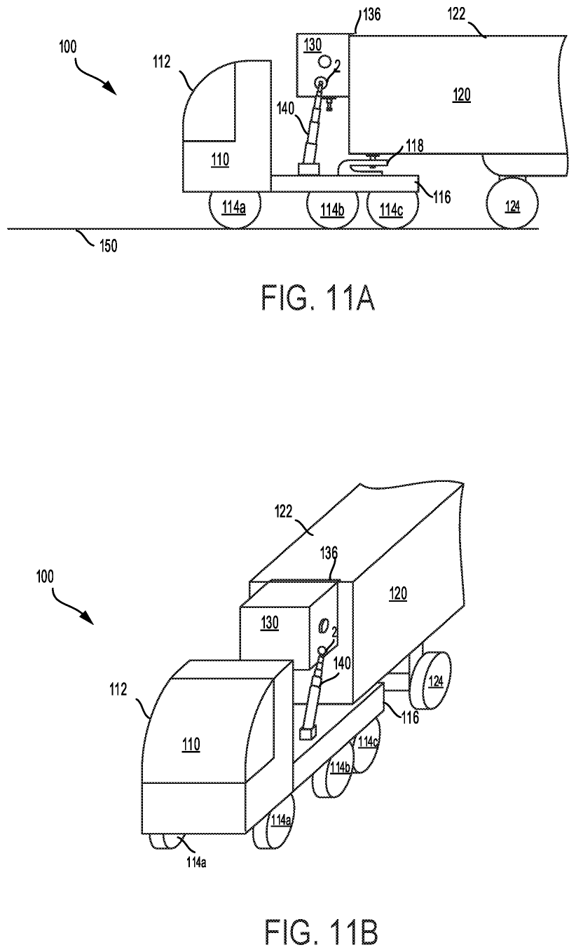

FIG. 11A illustrates a side view of the exemplary system 100 in which the actuator 140 has been retracted from the position 1 to the position 2, according to an example embodiment of the present disclosure. FIG. 11B illustrates a perspective view of the exemplary system 100 in FIG. 11A, according to an example embodiment of the present disclosure. As shown in FIGS. 11A and 11B, the second end 144 of the actuator 140 has been retracted with respect to the first end 142 of the actuator 140 from the position 1 to the position 2 at which the second end 144 of the actuator 140 is decoupled from the second coupling member 134 of the battery pack 130.

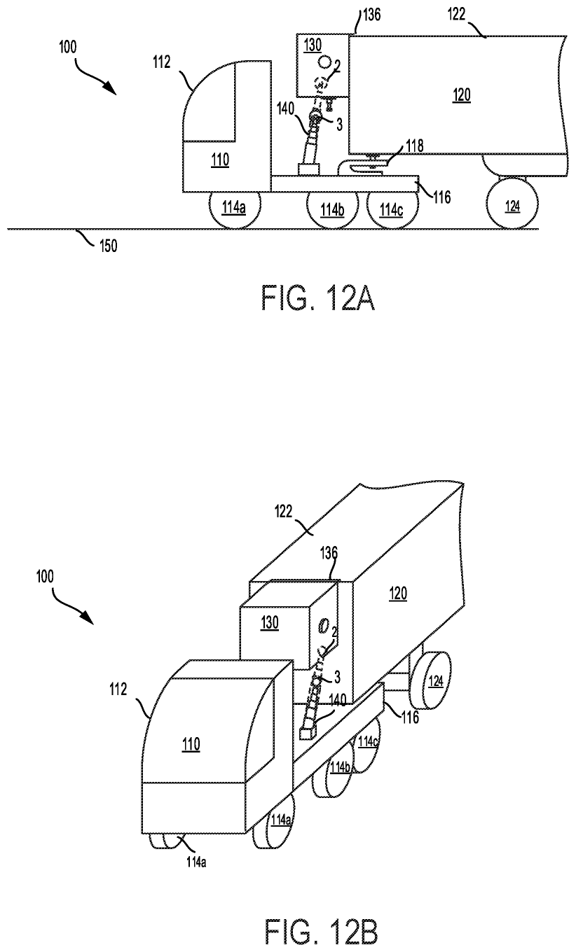

FIG. 12A illustrates a side view of the exemplary system 100 in which the actuator 140 is further retracted from the position 2 to a position 3, according to an example embodiment of the present disclosure. FIG. 12B illustrates a perspective view of the exemplary system 100 in FIG. 12A, according to an example embodiment of the present disclosure. The second end 144 of the actuator 140 may be further retracted with respect to the first end 142 of the actuator 140 from the position 2 to a position 3. This may be achieved by retracting one further step of the actuator 140 (e.g., one step of a telescopic hydraulic actuator). A process of retracting the actuator 140 from the positon 2 to the position 3 is shown by dashed lines illustrating the movement of the second end 144 of the actuator 140 from the position 2 to the position 3 in FIGS. 12A and 12B.

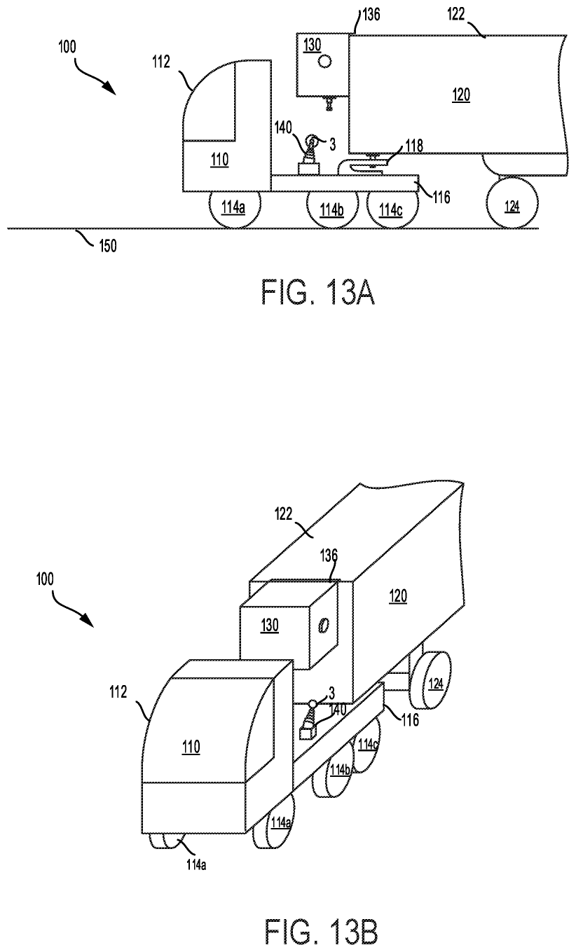

FIG. 13A illustrates a side view of the exemplary system 100 in which the actuator 140 has been retracted from the position 2 to the position 3, according to an example embodiment of the present disclosure. FIG. 13B illustrates a perspective view of the exemplary system 100 in FIG. 13A, according to an example embodiment of the present disclosure. As shown in FIGS. 13A and 13B, the second end 144 of the actuator 140 has been further retracted with respect to the first end 142 of the actuator 140 from the position 2 to the position 3. The positions 2 and 3 may be referred to as retracted positions of the actuator 140.

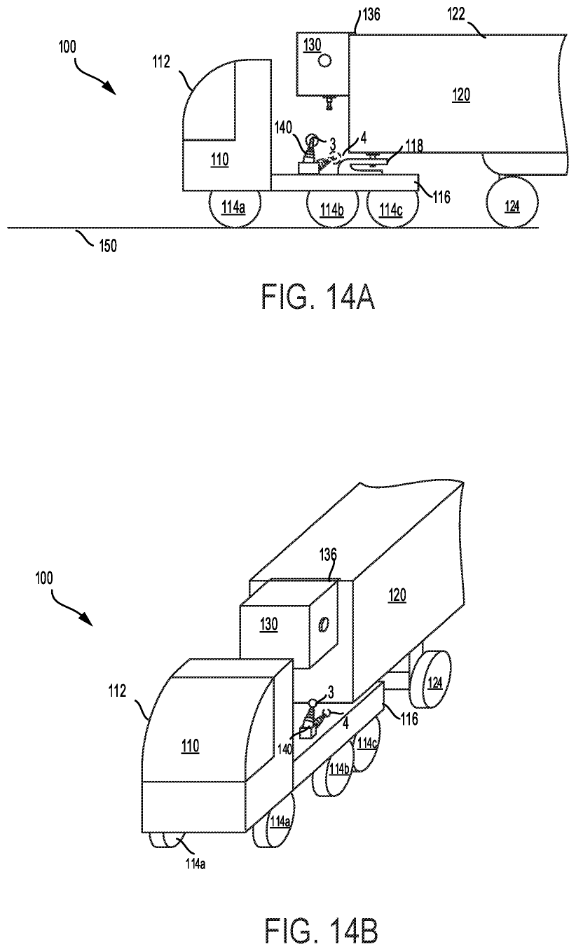

FIG. 14A illustrates a side view of the exemplary system 100 in which the actuator 140 is further moved from the position 3 to a position 4, according to an example embodiment of the present disclosure. FIG. 14B illustrates a perspective view of the exemplary system 100 in FIG. 14A, according to an example embodiment of the present disclosure. To move the actuator 140 to its initial position at which the actuator 140 is coupled to the battery pack 130 that is coupled to the fifth wheel 118, the actuator 140 may need to be moved from the retracted position 3 to a position 4, as shown in FIGS. 14A and 14B. Moving to the position 4 may be achieved by rotating the actuator 140 with respect to the vehicle frame 116 from the positon 3 to the position 4. In some embodiments, rotating the actuator 140 with respect to the vehicle frame 116 from the positon 3 to the position 4 may be facilitated by a second actuator (not shown in FIGS. 14A and 14B, and will be described later in detail in the disclosure). For example, the second actuator may have a first end and a second end opposite the first end of the second actuator. The first end of the second actuator may be adapted to rotatably couple to the vehicle frame 116 to move the second end of the second actuator between a raised position and a lowered position. The second actuator may be configured to be coupled to the actuator 140, wherein in the raised position the actuator 140 is in a first position (e.g., the position 3) and in the lowered position the actuator 140 is in a second position (e.g., the positon 4), whereby the actuator 140 is moved from the position 3 to the position 4.

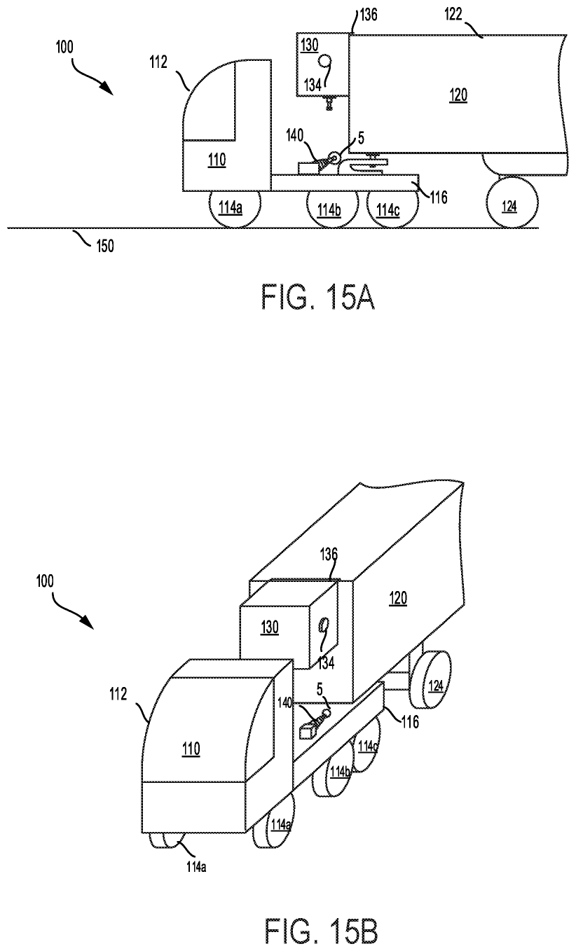

FIG. 15A illustrates a side view of the exemplary system 100 in which the actuator 140 has been moved to a final position 5, according to an example embodiment of the present disclosure. FIG. 15B illustrates a perspective view of the exemplary system 100 in FIG. 15A, according to an example embodiment of the present disclosure. As shown in FIGS. 15A and 15B, the actuator 140 is moved to a final position 5. There may have one or more further movements of the actuator 140 after the position 4 and prior to the final position 5. Moving to the final position 5 may be achieved by rotating the actuator 140 with respect to the vehicle frame 116 from the positon 4 to the position 5. In some embodiments, rotating the actuator 140 with respect to the vehicle frame 116 from the positon 4 to the position 5 may be facilitated by the second actuator mentioned above (not shown in FIGS. 15A and 15B, and will be described later in detail in the disclosure).

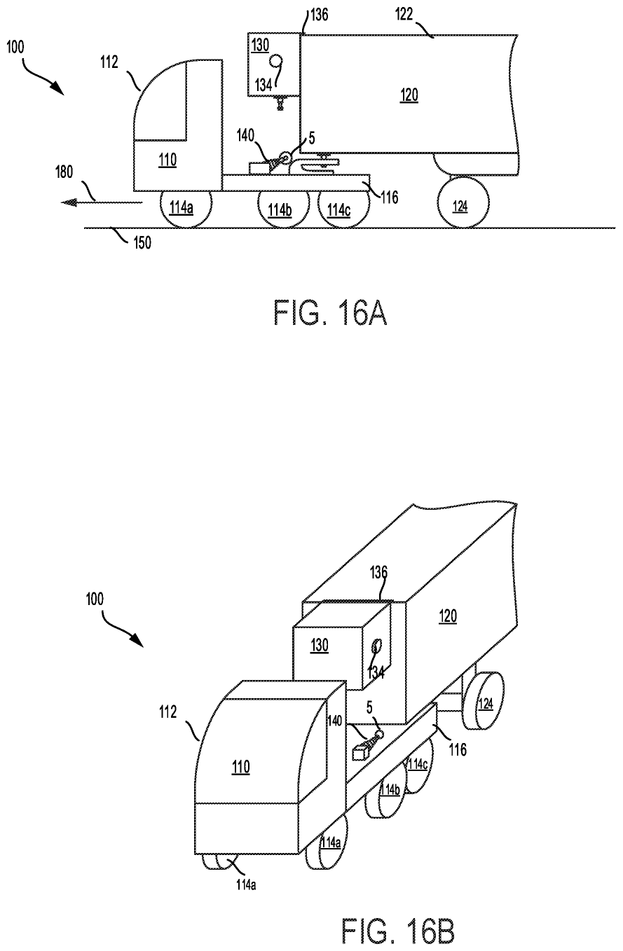

FIG. 16A illustrates a side view of the exemplary system 100 in which the actuator 140 is at the final position 5 and the electric tractor 110 coupled to the trailer 120 starts traveling, according to an example embodiment of the present disclosure. FIG. 16B illustrates a perspective view of the exemplary system 100 in FIG. 16A, according to an example embodiment of the present disclosure. As shown in FIGS. 15A and 15B, the actuator 140 is at the final position 5. At the final position 5, the electric tractor 110 is coupled to the trailer 110, and the battery pack 130 is coupled to the trailer 120. The electric tractor 110 coupled to the trailer 120 may be ready for traveling, as shown by the arrow 180.

The disclosure now refers to various embodiments of the actuator 140, the first and second coupling members of the battery pack 130, the second actuator, and a coupling structure adapted to couple the battery pack 130 to the trailer 120.

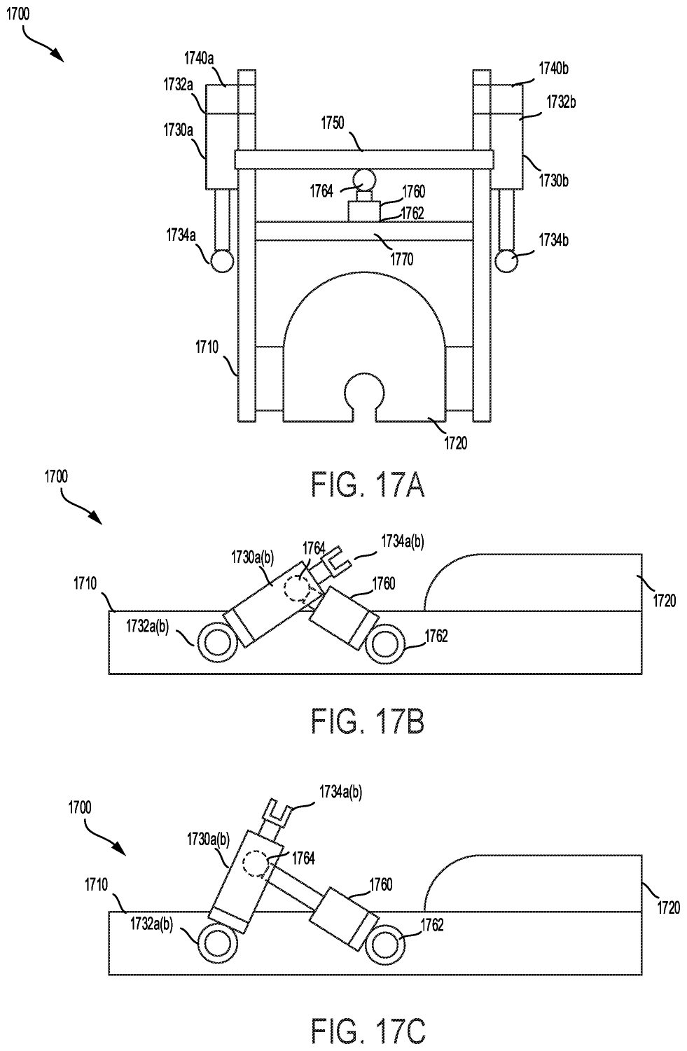

FIG. 17A illustrates a top view of a battery pack maneuvering system 1700 according to an example embodiment of the present disclosure. FIG. 17B illustrates a side view of the battery pack maneuvering system 1700 according to an example embodiment of the present disclosure. FIG. 17C illustrates another side view of the battery pack maneuvering system 1700 according to an example embodiment of the present disclosure. The battery pack maneuvering system 1700 may be used in the system 100 described above for handling the battery pack 130.

As shown in FIGS. 17A-C, the battery pack maneuvering system 1700 may comprise a vehicle frame 1710 having a fifth wheel 1720, an actuator 1730 (referring to 1730a and 1730b) which may have two sub-actuators 1730a and 1730b, a coupling device 1740 (referring to 1740a and 1740b) adapted to couple the actuator 1730 to the vehicle frame 1710, a horizontal bar or beam 1750 in between the two sub-actuators 1730a and 1730b to connect the two sub-actuators 1730a and 1730b, and a second actuator 1760.

The actuator 1730 may have a first end 1732 (referring to 1732a and 1732b) and a second end 1734 (referring to 1734a and 1734b) opposite the first end 1732. The first end 1732 may be adapted to rotatably couple to the vehicle frame 1710 having the fifth wheel 1720 and to move between a first position (as shown in FIG. 17B) and a second position (as shown in FIG. 17C). The second end 1734 may be extendable and retractable with respect to the first end 1732 to move between an extended position and a retracted position and is adapted to removably couple to a battery pack (e.g., the battery pack 130).

The coupling device 1740 may be adapted to couple the actuator 1730 to an outside of the vehicle frame 1710. The coupling device 1740 may comprise a universal joint, a hinge, a pin, a nut, a bolt, etc. that can rotatably couple the actuator 1730 via the first end 1732 of the actuator 1730 to the vehicle frame 1710, such that the actuator 1730 can move between the first position (as shown in FIG. 17B) and the second position (as shown in FIG. 17C).

The horizontal bar 1750 in between the two sub-actuators 1730a and 1730b may have a first end adapted to connect to one sub-actuator and a second end adapted to connect to another sub-actuator. The horizontal bar 1750 may be used to coordinate movements of the two sub-actuators, and also to support and reinforce the two sub-actuators.

The second actuator 1760 may have a first end 1762 and a second end 1764 opposite the first end 1762 of the second actuator 1760. The first end 1762 of the second actuator 1760 may be adapted to rotatably couple to the vehicle frame 1710 to move the second end 1764 of the second actuator 1760 between a raised position (as shown in FIG. 17C) and a lowered position (as shown in FIG. 17B). The first end 1762 of the second actuator 1760 may be coupled to a substantially central portion between a left side and a right side of the vehicle frame 1710, and may be further reinforced with a bar or beam 1770 to the vehicle frame 1710.

The second end 1764 of the second actuator 1760 may be configured to be extendable and retractable with respect to the first end 1762 of the second actuator 1760 to move between an extended position and a retracted positon. The second actuator 1760 may be adapted to couple to the actuator 1730 via the second end 1764 of the second actuator 1760. The second end 1764 of the second actuator 1760 may be adapted to connect to a substantially center portion of the horizontal bar 1750 between the first and second ends of the horizontal bar 1750 to couple to the two sub-actuators 1730a and 1730b.

When the second end 1764 of the second actuator 1760 is in the lowered or retracted position, the actuator 1730 is in the first position (as shown in FIG. 17B); when the second end 1764 of the second actuator 1760 is in the raised or extended position, the actuator 1730 is in the second position (as shown in FIG. 17C), whereby the battery pack can be moved from a connected position coupled to the fifth wheel 1720 via a coupling member of the battery pack to a transfer position for transfer to a trailer.

The battery pack may include a first coupling member adapted to removably couple to the fifth wheel 1720 and a second coupling member adapted to removably couple to the second end (1734a and 1734b) of the actuator 1730 (1730a and 1730b).

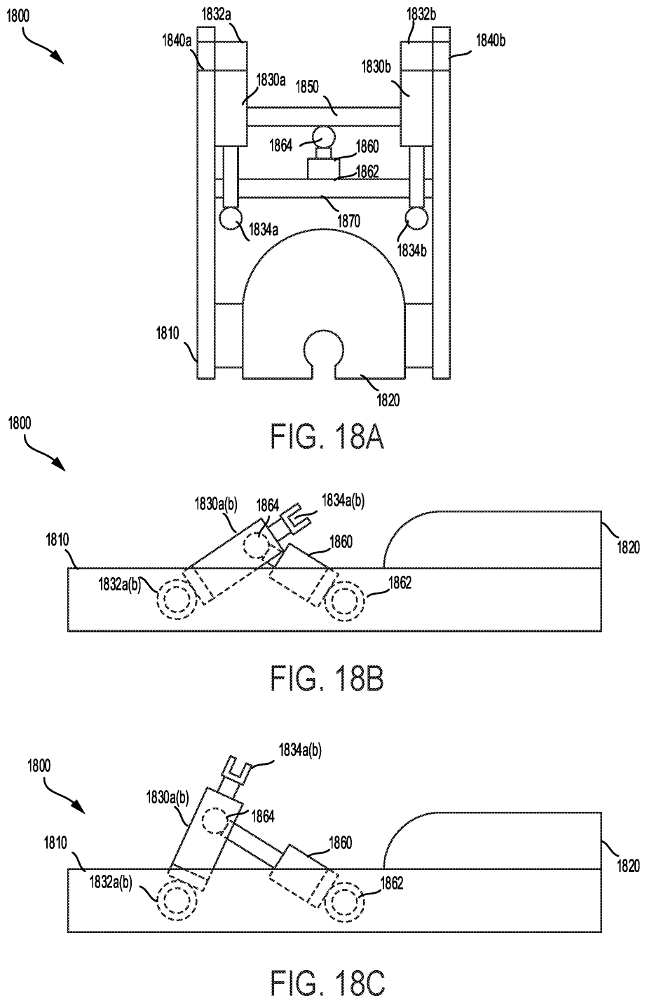

FIG. 18A illustrates a top view of a battery pack maneuvering system 1800 according to an example embodiment of the present disclosure. FIG. 18B illustrates a side view of the battery pack maneuvering system 1800 according to an example embodiment of the present disclosure. FIG. 18C illustrates another side view of the battery pack maneuvering system 1800 according to an example embodiment of the present disclosure. The battery pack maneuvering system 1800 may be used in the system 100 described above for handling the battery pack 130.

As shown in FIGS. 18A-C, the battery pack maneuvering system 1800 may comprise a vehicle frame 1810 having a fifth wheel 1820, an actuator 1830 (referring to 1830a and 1830b) which may have two sub-actuators 1830a and 1830b, a coupling device 1840 (referring to 1840a and 1840b) adapted to couple the actuator 1830 to the vehicle frame 1810, a horizontal bar or beam 1850 in between the two sub-actuators 1830a and 1830b to connect the two sub-actuators 1830a and 1830b, and a second actuator 1860.

The actuator 1830 may have a first end 1832 (referring to 1832a and 1832b) and a second end 1834 (referring to 1834a and 1834b) opposite the first end 1832. The first end 1832 may be adapted to rotatably couple to the vehicle frame 1810 having the fifth wheel 1820 and to move between a first position (as shown in FIG. 18B) and a second position (as shown in FIG. 18C). The second end 1834 may be extendable and retractable with respect to the first end 1832 to move between an extended position and a retracted position and is adapted to removably couple to a battery pack (e.g., the battery pack 130).

The coupling device 1840 may be adapted to couple the actuator 1830 to an inner side of the vehicle frame 1810. The coupling device 1840 may comprise a universal joint, a hinge, a pin, a nut, a bolt, etc. that can rotatably couple the actuator 1830 via the first end 1832 of the actuator 1830 to the vehicle frame 1810, such that the actuator 1830 can move between the first position (as shown in FIG. 18B) and the second position (as shown in FIG. 18C).

The horizontal bar 1850 in between the two sub-actuators 1830a and 1830b may have a first end adapted to connect to one sub-actuator and a second end adapted to connect to another sub-actuator. The horizontal bar 1850 may be used to coordinate movements of the two sub-actuators, and also to support and reinforce the two sub-actuators.

The second actuator 1860 may have a first end 1862 and a second end 1864 opposite the first end 1862 of the second actuator 1860. The first end 1862 of the second actuator 1860 may be adapted to rotatably couple to the vehicle frame 1810 to move the second end 1864 of the second actuator 1860 between a raised position (as shown in FIG. 18C) and a lowered position (as shown in FIG. 18B). The first end 1862 of the second actuator 1860 may be coupled to a substantially central portion between a left side and a right side of the vehicle frame 1810, and may be further reinforced with a bar or beam 1870 to the vehicle frame 1810.

The second end 1864 of the second actuator 1860 may be configured to be extendable and retractable with respect to the first end 1862 of the second actuator 1860 to move between an extended position and a retracted positon. The second actuator 1860 may be adapted to couple to the actuator 1830 via the second end 1864 of the second actuator 1860. The second end 1864 of the second actuator 1860 may be adapted to connect to a substantially center portion of the horizontal bar 1850 between the first and second ends of the horizontal bar 1850 to couple to the two sub-actuators 1830a and 1830b.

When the second end 1864 of the second actuator 1860 is in the lowered or retracted position, the actuator 1830 is in the first position (as shown in FIG. 18B); when the second end 1864 of the second actuator 1860 is in the raised or extended position, the actuator 1830 is in the second position (as shown in FIG. 18C), whereby the battery pack can be moved from a connected position coupled to the fifth wheel 1820 via a coupling member of the battery pack to a transfer position for transfer to a trailer.

The battery pack may include a first coupling member adapted to removably couple to the fifth wheel 1820 and a second coupling member adapted to removably couple to the second end (1834a and 1834b) of the actuator 1830 (1830a and 1830b).

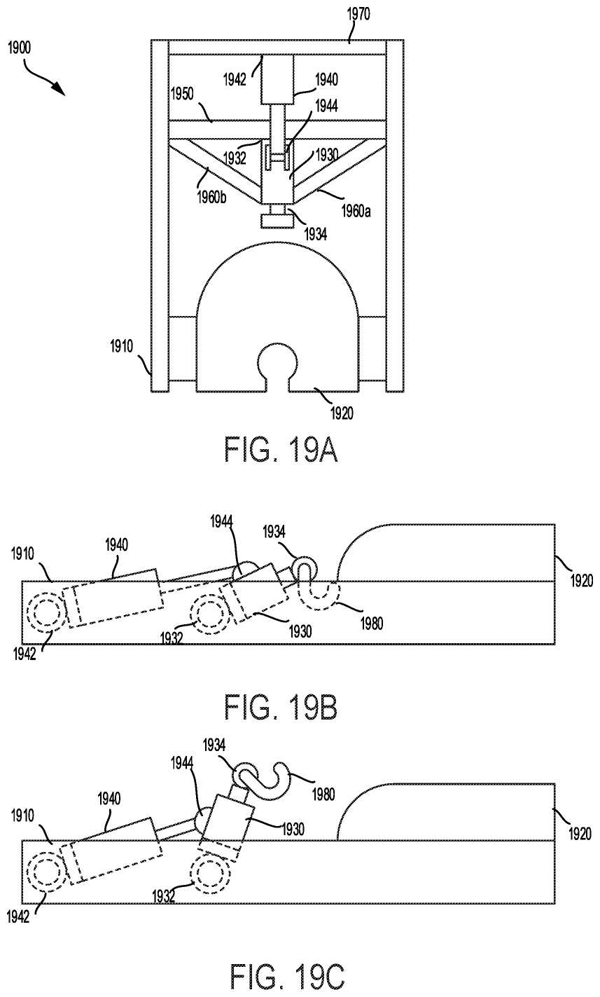

FIG. 19A illustrates a top view of a battery pack maneuvering system 1900 according to an example embodiment of the present disclosure. FIG. 19B illustrates a side view of the battery pack maneuvering system 1900 according to an example embodiment of the present disclosure. FIG. 19C illustrates another side view of the battery pack maneuvering system 1900 according to an example embodiment of the present disclosure. The battery pack maneuvering system 1900 may be used in the system 100 described above for handling the battery pack 130.

As shown in FIGS. 19A-C, the battery pack maneuvering system 1900 may comprise a vehicle frame 1910 having a fifth wheel 1920, an actuator 1930 adapted to couple to the vehicle frame 1910, and a second actuator 1940 adapted to couple to both the actuator 1930 and the vehicle frame 1910.

The actuator 1930 may have a first end 1932 and a second end 1934 opposite the first end 1932. The first end 1932 may be adapted to rotatably couple to the vehicle frame 1910 having the fifth wheel 1920 and to move between a first position (as shown in FIG. 19B) and a second position (as shown in FIG. 19C). The first end 1932 of the actuator 1930 may be coupled to a substantially central portion between a left side and a right side of the vehicle frame 1910. The first end 1932 of the actuator 1930 may be further reinforced and supported by a bar or beam 1950 that may hold the first end 1932 to the vehicle frame 1910.

The battery pack maneuvering system 1900 may further comprise two bars or beams 1960a and 1960b adapted to rotate with respect to the vehicle frame 1910. Each of the two bars 1960a and 1960b has a first end and a second end opposite to the first end of the bar. The first end of the bar is adapted to couple to a side of the vehicle frame 1910, and the second end of the bar is adapted to couple to the actuator 1930. In such way, the actuator 1930 may be reinforced and supported by the two bars 1960a and 1960b, and movement of the actuator 1930 may be coordinated by the two bars 1960a and 1960b.

The second end 1934 of actuator 1930 may be extendable and retractable with respect to the first end 1932 to move between an extended position and a retracted position, and may be adapted to removably couple to a battery pack (e.g., the battery pack 130) via a hook-shaped coupling member 1980.

The second actuator 1940 may have a first end 1942 and a second end 1944 opposite the first end 1942 of the second actuator 1940. The first end 1942 of the second actuator 1940 may be adapted to rotatably couple to the vehicle frame 1910 to move the second end 1944 of the second actuator 1940 between a raised position (as shown in FIG. 19C) and a lowered position (as shown in FIG. 19B). The first end 1942 of the second actuator 1940 may be coupled to a substantially central portion between a left side and a right side of the vehicle frame 1910, and may be further reinforced with a bar or beam 1970 to the vehicle frame 1910.

The second end 1944 of the second actuator 1940 may be configured to be extendable and retractable with respect to the first end 1942 of the second actuator 1940 to move between an extended position and a retracted positon. The second actuator 1940 may be adapted to couple to the actuator 1930 via the second end 1944 of the second actuator 1940. The second end 1944 of the second actuator 1940 may be adapted to connect to a lower portion of the actuator 1930 between the first and second ends 1932 and 1934 of the actuator 1930 to couple to the actuator 1930.

When the second end 1944 of the second actuator 1940 is in the lowered or retracted position, the actuator 1930 is in the first position (as shown in FIG. 18B); when the second end 1944 of the second actuator 1940 is in the raised or extended position, the actuator 1930 is in the second position (as shown in FIG. 18C), whereby the battery pack can be moved from a connected position coupled to the fifth wheel 1920 via a coupling member of the battery pack to a transfer position for transfer to a trailer.

The battery pack may include a first coupling member adapted to removably couple to the fifth wheel 1920 and a second coupling member adapted to removably couple to the second end 1934 of the actuator 1930.

In an example embodiment, the actuators can be an electric actuator powered by a motor. In another embodiments, the actuators can be a twisted and coiled polymer (TCP) actuator which may be a coiled polymer that can be actuated by electric power. In yet another embodiment, the actuators can a thermal or magnetic actuators which can be actuated by applying thermal or magnetic energy. In yet another embodiment, the actuators can a mechanical actuator which executes movement by converting one kind of motion into another kind of motion.

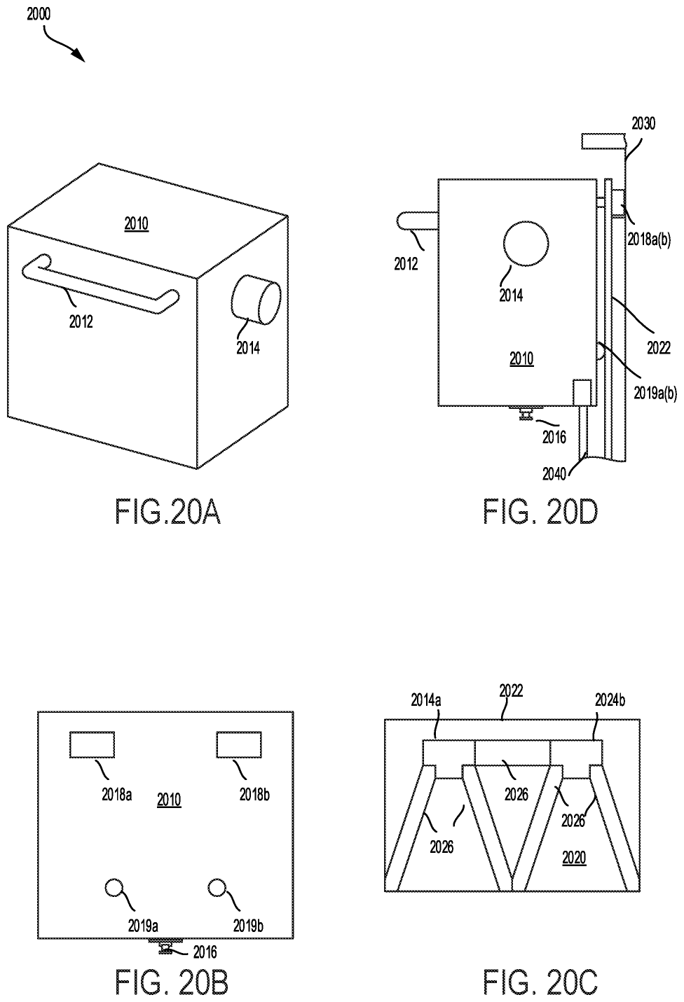

FIGS. 20A, 20B, 20C, and 20D illustrates an example system 2000 for coupling a battery pack to a trailer, according to an example embodiment of the present disclosure, among which, FIG. 20A illustrates a perspective view of an example battery pack; FIG. 20B illustrates a back side view facing a trailer of the example battery pack in FIG. 20A; FIG. 20C illustrates an example coupling structure adapted to coupling the example battery pack in FIG. 20A to the trailer; FIG. 20D illustrates a side view of the trailer and the example battery pack in FIG. 20A coupled to the trailer.

As shown in FIG. 20A, a battery pack 2010 may comprise a curved handle 2012 as a coupling member on a front surface of the battery pack 2010, and at least one pin-shaped protrusion 2014 as coupling members on side surfaces of the battery pack 2010. The curved handle 2012 may have a first end and a second end opposite the first end of the curved handle 2012. The first and second ends of the curved handle 2012 may be adapted to connect to the front surface of the battery pack 2010. A portion of the curved handle 2012 between the first and second ends of the curved handle 2012 may be adapted to removably couple to a second end of an actuator, for example, the actuator 140 in the system 100, the actuator 1730 in the system 1700, the actuator 1830 in the system 1800, and the actuator 1930 in the system 1900.

The at least one pin-shaped protrusions 2014 may comprise two pin-shaped protrusions. Each of the two pin-shaped protrusions may be adapted to connect to a corresponding side surface of the battery pack 2010 and extend away from the corresponding side surface of the battery pack 2010, respectively. The two pin-shaped protrusions may be adapted to couple to two corresponding second ends of two actuators (e.g., the actuator 140 in the system 100, the actuator 1730 in the system 1700, the actuator 1830 in the system 1800, and the actuator 1930 in the system 1900). For example, the second end 1734a of the one sub-actuator 1730a in the system 1700 can be adapted to removably couple to one pin-shaped protrusion 2014, whereby the battery pack 2010 can be moved from the connected position coupled to the fifth wheel to the transfer position for transfer to the trailer.

As shown in FIG. 20B, the battery pack 2010 may further comprise a pin 2016 as a coupling member to couple to a fifth wheel on a vehicle frame. The pin 2016 may have a first end and a second end opposite the first end of the pin 2016. The first end of the pin 2016 is adapted to connect to a bottom surface of the battery pack 2010, and the second end of the pin 2016 is adapted to extend away from the bottom surface of the battery pack 2010 to removably couple to the fifth wheel.

As shown in FIG. 20B, the battery pack 2010 may further comprise at least one peg-shaped protrusions on a back surface facing the trailer of the battery pack 2010, for example two peg-shaped protrusions 2018a and 2018b with necks of the two peg-shaped protrusions connected to the back surface of the battery pack 2010 facing to the trailer. The at least one peg-shaped protrusions may be adapted to couple the battery pack 2010 to the trailer.

Further as shown in FIG. 20B, the battery pack 2010 may further comprise at least at least one bumper at a lower portion of the back surface facing the trailer of the battery pack 2010, for example two bumpers 2019a and 2019b. The at least one bumper may be adapted to secure the battery pack 2010 to the trailer and to reduce vibration when the battery pack 2010 is coupled to the trailer.

As shown in FIG. 20C, a coupling structure 2020 may be adapted to fixedly attached to the trailer and to couple the battery pack 2010 to the trailer. The coupling structure 2020 may comprise a connector 2022 having corresponding surfaces to engage with the at least one peg-shaped protrusions of the battery pack 2010 such that the battery pack 2010 is coupled to the trailer from the transfer position.

The connector 2022 may comprises at least one recess to receive the at least one peg-shaped protrusions of the battery pack 2010, for example, two recesses 2024a and 2024b. The two peg-shaped protrusions 2018a and 2018b are adapted to be received by the two recesses 2024a and 204b correspondingly and to be locked in the two recesses 2024a and 2024b to couple the battery pack 2010 to the trailer (as shown in FIG. 20D).

The coupling structure 2020 may further comprise a reinforcement structure 2026 fixedly attached to a front side of the connector 2022 to reinforce the coupling structure and to transfer load of the battery pack 2010 to a chassis of the trailer.

A state of the battery pack 2010 being coupled to the trailer (trailer 2030) is shown in FIG. 20D. The battery pack 2010 is coupled to a front side of the trailer via the coupling structure 2020. In some embodiments, the coupling structure 2020 may further comprise a horizontal bar (not shown) to hold the battery pack 2010 in place when the battery pack 2010 is coupled to the trailer via the coupling structure 2020. The horizontal bar may be placed above the two peg-shaped protrusions 2018a and 2018b when the two peg-shaped protrusions 2018a are received by the two recesses 2024a and 2024b, such that the two peg-shaped protrusions 2018a and 2018b can be securely held inside the two recesses 2024a and 2024b. Further, as shown in FIG. 20D, the battery pack 2010 may further comprise one or more wires 2040 adapted to connect to a power system of the electric tractor to power the tractor and the trailer.

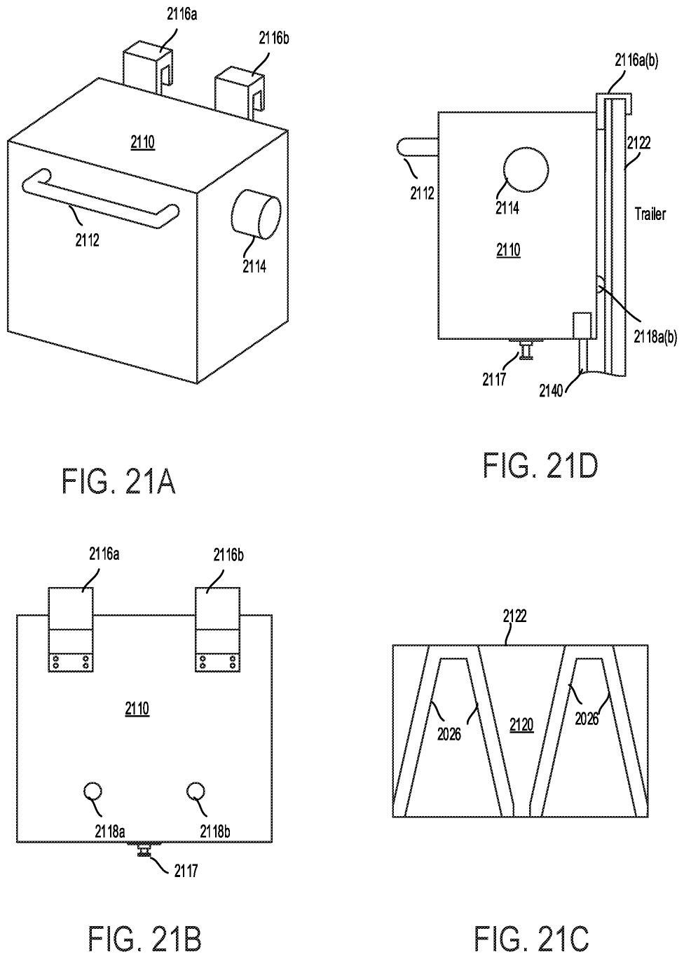

FIGS. 21A, 21B, 21C, and 21D illustrates an example system 2100 for coupling a battery pack to a trailer, according to an example embodiment of the present disclosure, among which, FIG. 21A illustrates a perspective view of an example battery pack; FIG. 21B illustrates a back side view facing a trailer of the example battery pack in FIG. 21A; FIG. 21C illustrates an example coupling structure adapted to coupling the example battery pack in FIG. 21A to the trailer; FIG. 21D illustrates a side view of the trailer and the example battery pack in FIG. 21A coupled to the trailer.

As shown in FIG. 21A, a battery pack 2110 may comprise a curved handle 2112 as a coupling member on a front surface of the battery pack 2110, and at least one pin-shaped protrusion 2114 as coupling members on side surfaces of the battery pack 2110. The curved handle 2112 may have a first end and a second end opposite the first end of the curved handle 2112. The first and second ends of the curved handle 2112 may be adapted to connect to the front surface of the battery pack 2110. A portion of the curved handle 2112 between the first and second ends of the curved handle 2112 may be adapted to removably couple to a second end of an actuator, for example, the actuator 140 in the system 100, the actuator 1730 in the system 1700, the actuator 1830 in the system 1800, and the actuator 1930 in the system 1900.

The at least one pin-shaped protrusions 2114 may comprise two pin-shaped protrusions. Each of the two pin-shaped protrusions may be adapted to connect to a corresponding side surface of the battery pack 2110 and extend away from the corresponding side surface of the battery pack 2110, respectively. The two pin-shaped protrusions may be adapted to couple to two corresponding second ends of two actuators (e.g., the actuator 140 in the system 100, the actuator 1730 in the system 1700, the actuator 1830 in the system 1800, and the actuator 1930 in the system 1900). For example, the second end 1734a of the one sub-actuator 1730a in the system 1700 can be adapted to removably couple to one pin-shaped protrusion 2114, whereby the battery pack 2110 can be moved from the connected position coupled to the fifth wheel to the transfer position for transfer to the trailer.

As shown in FIG. 21A, the battery pack 2110 may further comprise at least one two angled recesses or brackets (e.g., two angled recesses 2116a and 2116b) on a back surface facing the trailer of the battery pack 2110. The as least one angled recesses may be fixedly connected to the back surface of the battery pack 2110 via for example, rivets, threaded nuts, hinges, etc. as shown in FIG. 21B. The at least one angled recesses may be adapted to couple the battery pack 2110 to the trailer.

As shown in FIG. 21B, the battery pack 2110 may further comprise a pin 2117 as a coupling member to couple to a fifth wheel on a vehicle frame. The pin 2117 may have a first end and a second end opposite the first end of the pin 2117. The first end of the pin 2117 is adapted to connect to a bottom surface of the battery pack 2110, and the second end of the pin 2117 is adapted to extend away from the bottom surface of the battery pack 2110 to removably couple to the fifth wheel.

Further as shown in FIG. 21B, the battery pack 2110 may further comprise at least at least one bumper at a lower portion of the back surface facing the trailer of the battery pack 2110, for example two bumpers 2118a and 2118b. The at least one bumper may be adapted to secure the battery pack 2110 to the trailer and to reduce vibration when the battery pack 2110 is coupled to the trailer.

As shown in FIG. 21C, a coupling structure 2120 may be adapted to fixedly attached to the trailer and to couple the battery pack 2110 to the trailer. The coupling structure 2120 may comprise a connector 2122 having corresponding surfaces to engage with the at least one angled recesses of the battery pack 2110 such that the battery pack 2110 is coupled to the trailer from the transfer position. The connector 2122 may comprise an edge portion having a height greater than heights of other sides of the trailer, and the two angled recesses 2116a and 2116b may be adapted to receive the edge portion such that the battery pack 2110 is coupled to the trailer (as shown in FIG. 21D).

The coupling structure 2120 may further comprise a reinforcement structure 2126 fixedly attached to a front side of the connector 2122 to reinforce the coupling structure 2120 and to transfer load of the battery pack 2110 to a chassis of the trailer.

A state of the battery pack 2110 being coupled to the trailer is shown in FIG. 20D. The battery pack 2110 is coupled to a front side of the trailer via the coupling structure 2120. In some embodiments, the coupling structure 2120 may further comprise a horizontal bar (not shown) to hold the battery pack 2110 in place when the battery pack 2110 is coupled to the trailer via the coupling structure 2120. The horizontal bar may be placed above the two angled recesses 2116a and 2116b when the two angled recesses 2116a and 2116b receive the edge portion of the connector 2122, such that the two angled recesses 2116a and 2116b can be securely held onto the edge portion of the connector 2122. In some embodiments, the coupling structure 2120 may further comprise at least one stopper (not shown) adapted to engage with the edge portion of the connector 2122 to prevent the battery pack 2110 from sliding sideway along the edge portion when the battery pack 2110 is coupled to the trailer. Further, as shown in FIG. 20D, the battery pack 2110 may further comprise one or more wires 2140 adapted to connect to a power system of the electric tractor to power the tractor and the trailer.

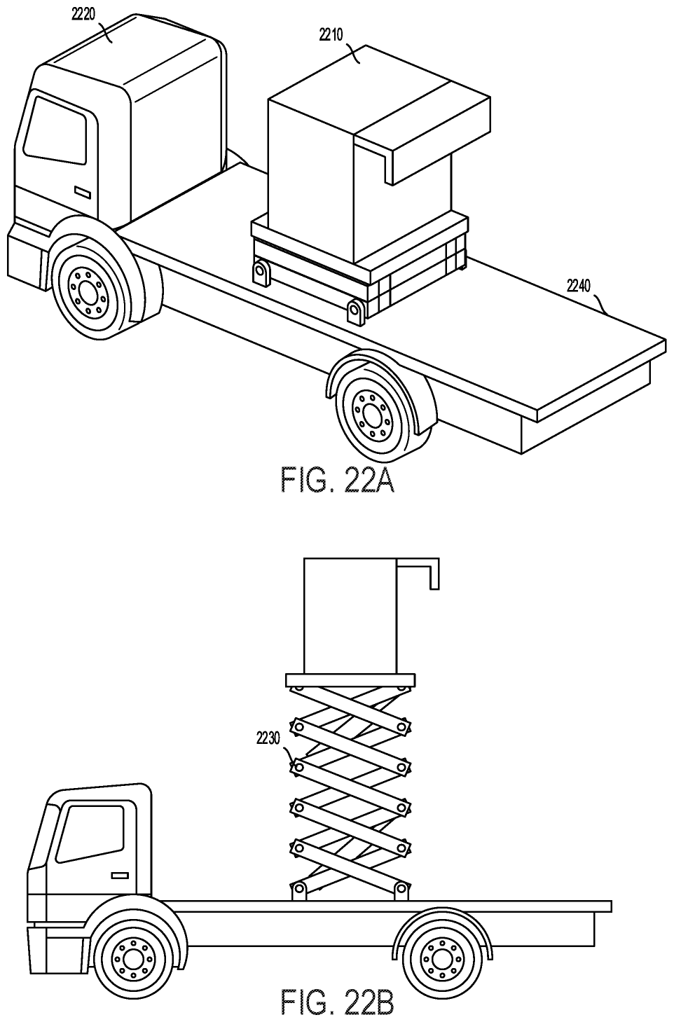

The actuator may take many different forms within the overall context of moving the battery pack from the fifth wheel to another location, such as a trailer. In some embodiments, the actuator can be in a form of a crane. As shown in FIGS. 22A and 22B, an example battery pack 2210 is secured to a fifth wheel of a vehicle 2220. An actuator 2230 embodied as a crane is configured to move along one or more rails. The rails may be on a frame 2240 of the vehicle 2220. The actuator 2230 can move along the rails to engage the battery pack 2210. The actuator 2230 can move to lift and lower the battery pack 2210, respectively. In an example, the crane may extend upward and retract downward. Thereby the actuator 2230 can manipulate the battery pack 2210 to engage and disengage the battery pack 2210 with the fifth wheel, as well as to engage and disengage the battery pack 2210 with a trailer.

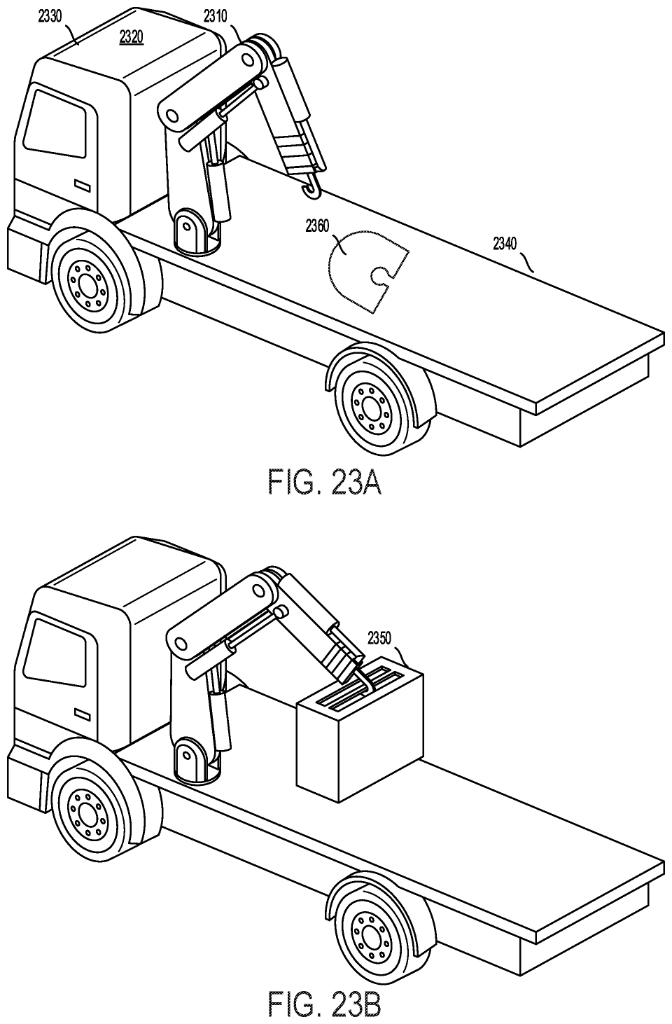

In some embodiments, the actuator can be positioned behind a cap of a vehicle. As shown in FIGS. 23A and 23B, an example actuator 2310 is configured to be behind a cap 2320 of a vehicle 2330. The actuator 2310 may be fixed behind the cab 2320 or can be movable. In an example, one or more rails on a frame 2340 of the vehicle 2330 may be provided for moving the actuator. The actuator 2310 can manipulate a battery pack 2350 to engage and disengage the battery pack 2350 with a fifth wheel 2360 of the vehicle 2330, as well as to engage and disengage the battery pack 2350 with a trailer.

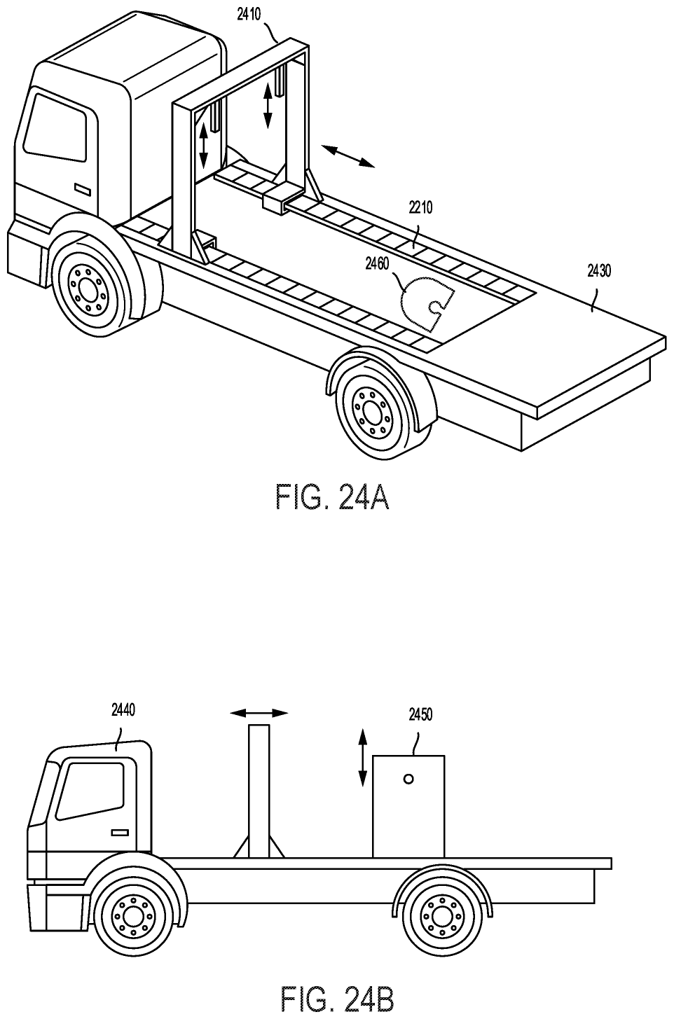

In some embodiments, the actuator can be in a form of a truss system. As shown in FIGS. 24A and 24B, an actuator 2410 embodied as a truss system is shown and configured to be movable. In an example, one or more rails 2420 on a frame 2430 of a vehicle 2440 may be provided for moving the actuator 2410. The actuator 2410 can move along the rails 2420 to engage a battery pack 2450. Thereby the actuator 2410 can manipulate the battery pack 2450 to engage and disengage the battery pack 2450 with the fifth wheel 2460, as well as to engage and disengage the battery pack 2450 with a trailer.

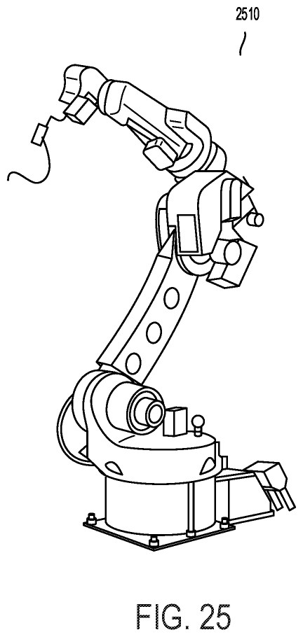

In some embodiments, the actuator can be in a form of a robot. As shown in FIG. 25, an example actuator 2510 is configured to be used for manipulating a battery pack. The actuator 2510 may be fixed to a frame of a vehicle or can be movable. In an example, one or more rails on the frame of the vehicle may be provided for moving the actuator 2510. The actuator 2510 can manipulate a battery pack to engage and disengage the battery pack with a fifth wheel of the vehicle, as well as to engage and disengage the battery pack with a trailer.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A battery pack maneuvering system, comprising:
a battery pack provided with a fifth wheel coupling member that removably couples the battery pack to a fifth wheel of a vehicle; and
an actuator mounted onto the vehicle that is removably coupled to the battery pack and that removes the battery pack from the fifth wheel.

2. The system of claim 1, wherein the actuator is adapted to transfer the battery pack to a trailer that may be coupled to the fifth wheel after the battery pack is removed from the fifth wheel.

3. The system of claim 2, wherein the actuator is adapted to lift and remove the battery pack from the fifth wheel to a location forward of the fifth wheel so that the trailer may couple to the fifth wheel.

4. The system of claim 2, further comprising the trailer, wherein after the trailer is coupled to the fifth wheel the actuator moves the battery pack to the trailer whereat a trailer coupling member on the battery pack couples the battery pack to the trailer.

5. The system of claim 2, further comprising the trailer, wherein:
after the trailer is coupled to the fifth wheel the actuator moves the battery pack to the trailer whereat a trailer coupling member on the battery pack couples the battery pack to the trailer; and
the actuator uncouples from the battery pack after the battery pack couples to the trailer.

6. The system of claim 2, further comprising the trailer, wherein:
after the trailer is coupled to the fifth wheel the actuator moves the battery pack to the trailer whereat a trailer coupling member on the battery pack couples the battery pack to the trailer; and
after the trailer is coupled to the fifth wheel, the actuator removes the battery pack from the trailer and the trailer is subsequently uncoupled from the fifth wheel.

7. The system of claim 1, wherein the actuator is telescopic.

8. The system of claim 1, wherein the actuator comprises a crane.

9. The system of claim 1, wherein the actuator is configured to be fixed behind the body of the vehicle and forward of the fifth wheel.

10. The system of claim 1, wherein the actuator comprises a truss system configured to be movable along one or more rails on a frame of the vehicle.

11. The system of claim 1, wherein the actuator comprises a robot configured to be movable along one or more rails on a frame of the vehicle.

12. A system for maneuvering a battery pack and coupling the battery pack to a trailer, comprising:
a battery pack provided with a fifth wheel coupling member that removably couples the battery pack to a fifth wheel of a vehicle and a second coupling member adapted to removably couple to a trailer;
an actuator mounted onto the vehicle to move the battery pack from the fifth wheel, whereby the battery pack is moved from a connected position coupled to the fifth wheel via the fifth wheel coupling member to a transfer position for transfer to the trailer;
a trailer configured to be coupled to the fifth wheel; and
a coupling structure adapted to fixedly attach to the trailer and to couple the battery pack to the trailer, the coupling structure comprises a connector having corresponding surfaces to engage with the second coupling member of the battery pack such that the battery pack is coupled to the trailer from the transfer position.

13. The system of claim 12, wherein the second coupling member of the battery pack comprises at least one bumper at a lower portion of the battery pack facing the trailer.

14. The system of claim 12, wherein the actuator comprises a crane.

15. The system of claim 12, wherein the actuator is configured to be fixed behind the body of the vehicle and forward of the fifth wheel.

16. The system of claim 12, wherein the actuator comprises a truss system configured to be movable along one or more rails on a frame of the vehicle.

17. The system of claim 12, wherein the actuator comprises a robot configured to be movable along one or more rails on a frame of the vehicle.
